(19) United States
(12) Patent Application Publication
(10) Pub. No.: US 2013/0248055 A1
(43) Pub. Date: Sep. 26, 2013

(54) Multi-Phase Steel, Cold-Rolled Flat Product Produced from Such a Multi-Phase Steel and Method for Producing It

(71) Applicants: Ekaterina Bocharova, Duisburg (DE); Dorothea Mattissen, Mulheim (DE); Roland Sebald, Geldern (DE); Daniel Krizan, Linz (AT); Andreas Pichler, Vocklabruck (AT)

(72) Inventors: Ekaterina Bocharova, Duisburg (DE); Dorothea Mattissen, Mulheim (DE); Roland Sebald, Geldern (DE); Daniel Krizan, Linz (AT); Andreas Pichler, Vocklabruck (AT)

(73) Assignee: THYSSENKRUPP STEEL EUROPE AG, Duisburg (DE)

(21) Appl. No.: 13/877,816

(22) PCT Filed: Sep. 27, 2011
(86) PCT No.: PCT/EP2011/066774

§ 371 Date: Jun. 13, 2013

(30) Foreign Application Priority Data
Oct. 5, 2010 (EP) 10186555.8

(51) Int. Cl. C21D 8/02

(52) U.S. Cl. CPC C21D 8/0263
USPC 148/522; 148/547; 148/328; 420/120

(57) ABSTRACT

A multi-phase steel which in addition to iron and unavoidable impurities includes (in % wt.) C: 0.14-0.25%, Mn: 1.7-2.5%, Si: 1.4-2.0%, Al: <0.1%, Cr: <0.1%, Mo: <0.05%, Nb: 0.02-0.06%, S: up to 0.01%, P: up to 0.02%, N: up to 0.01% and optionally one of Ti, B, and V according to the following stipulation: Ti: ≦0.1%, B: ≦0.002%, V: ≦0.15%. A cast semi-finished product, is hot rolled starting at an initial temperature of 1100-1300° C. and ending at a final temperature of 820-950° C., coiled at 400-750° C., cold rolled into the cold flat product at degrees of 30-80%, and subjected to a heat treatment including continuous annealing at 20° C.+A_{c1}-A_{c3} and overageing at 350-500° C.

The invention relates to a method for producing a cold flat product, to a multi-phase steel and to a cold-rolled flat product produced from such a multi-phase steel by cold rolling. The “flat products” according to the invention can be sheets, strips, blanks obtained from them or comparable products. When “cold flat products” are mentioned here, what is meant are flat products produced by cold rolling.

There is a requirement for materials, particularly in vehicle body construction, which, on the one hand, have high strengths and, on the other hand, are also deformable to such an extent that intricately shaped components can be formed from them by simple means.

A multi-phase steel, which should have a profile of properties which is balanced in this respect, is known from EP 1 367 143 A1. In addition to a comparatively high strength and good deformability, the known steel should also have particularly good weldability.

The known steel contains 0.03-0.25% wt. C for this purpose, through the presence of which, in combination with other alloying elements, tensile strengths of at least 700 MPa are to be reached. In addition, the strength of the known steel is to be supported by Mn in contents of 1.4-3.5% wt. Al is used as an oxidising agent when melting the known steel and can be present in the steel in contents of up to 0.1% wt. The known steel can also have up to 0.7% wt, Si, the presence of which enables the ferritic-martensitic structure of the steel to be stabilised. Cr is added to the known steel in contents of 0.05-1% wt., in order to reduce the effect of the heat introduced in the area of the weld seam by the welding process. For the same purpose, 0.005-0.1% wt. Nb are present in the known steel. Nb is additionally to have a positive effect on the deformability of the steel, since its presence brings with it a refinement of the ferrite grain. For the same purpose, 0.05-1% wt. Mo, 0.02-0.5% wt. V, 0.005-0-0-05% wt. Ti and 0.0002-0.002% wt. B can be added to the known steel. Mo and V contribute to the hardenability of the known steel, whilst Ti and B are additionally to have a positive effect on the strength of the steel.

Another steel sheet, which consists of a high-strength multi-phase steel and can be deformed well, is known from EP 1 589 126 B1. This known steel sheet contains 0.10-0.28% wt. C, 1.0-2.0% wt. Si, 1.0-3.0% wt. Mn, 0.03-0.10% wt. Nb, up to 0.5% wt. Al, up to 0.15% wt. P and up to 0.02% wt. S. Optionally, up to 1.0% wt. Mo, up to 0.5% wt. Ni, up to 0.5% wt. Cu, up to 0.003% wt. Ca, up to 0.003% wt. rare earth metals, up to 0.1% wt. Ti or up to 0.1% wt. V can be present in the steel sheet. The microstructure of the known steel sheet in relation to its overall structure has a residual austenite content of 5-20% and at least 50% bainitic ferrite. At the same time, the proportion of polygonal ferrite in the microstructure of the known steel sheet is to be at most 30%. By limiting the proportion of polygonal ferrite, bainite is to form the matrix phase in the known steel sheet and residual austenite portions are to be present which contribute to the balance of tensile strength and deformability. The presence of Nb is also to ensure that the residual austenite portion of the microstructure is fine-grained. In order to guarantee this effect, in the course of producing the steel sheet known from EP 1 589 126 B1 a particularly high initial temperature for hot rolling of 1250-1350° C. is chosen. In this temperature range, Nb goes fully into solid solution, so that when hot rolling the steel a large number of fine Nb carbides form, which are present in the polygonal ferrite or in the bainite.

EP 1 589 126 B1 goes on to say that although the high initial temperature for the hot rolling is the prerequisite for the fineness of the residual austenite, it does not on its own have the desired effect. Rather, for this purpose, final annealing at temperatures above the A_{c3} temperature, subsequent controlled cooling at a cooling rate of at least 10° C./s to a temperature in the range from 300-450° C., at which the bainite transformation takes place, and finally maintaining this temperature over a sufficiently long period of time are also required.

Against the background of the previously described prior art, the object of the invention was to specify a method for producing a cold flat product from a multi-phase steel having TRIP properties, which has a further increased strength with, at the same time, a high elongation at break. A multi-phase steel and a flat product having this combination of properties should also be created.

With respect to the method, the above specified object is achieved according to the invention by performing the production steps specified in Claim 1.

With regard to the steel, the previously specified object is achieved according to the invention by a steel constituted according to Claim 8.

Finally, with regard to the flat product, the above mentioned object is achieved by a cold flat product formed according to Claim 16.

Advantageous embodiments of the invention are specified in the dependent claims and are explained in detail below together with the general concepts of the invention.

A multi-phase steel according to the invention contains (in % wt.) C: 0.14-0.25%, Mn: 1.7-2.5%, Si: 1.4-2.0%, Al: <0.1%, Cr: <0.1%, Mo: <0.05%, Nb: 0.02-0.06%, S: up to 0.01%, P: up to 0.02%, N: up to 0.01% and optionally at least one element from the group “Ti, B, V”, according to the following stipulation: Ti: up to 0.1%, B: up to 0.002%, V: up to 0.15%, with the remainder iron and unavoidable impurities.

In the course of the method according to the invention, the steel according to the invention is melted and cast into a semi-finished product. This semi-finished product can be a slab or a thin slab.

The semi-finished product is then, as required, reheated to a temperature of 1100-1300° C., in order to obtain a microstructure of the base product which is uniformly heated through, Reheating temperatures of a maximum of 1250° C., in particular a maximum of 1220° C., lead to an improved surface of the product produced according to the invention, with optimised production costs.

Starting from the reheating temperature, the semi-finished product is subsequently hot rolled into a hot strip. The final temperature of the hot rolling is 820-950° C. according to the invention, in order to ensure a good initial state of the microstructure for cooling on the run-out rolling passed through following hot rolling.

The hot strip obtained is subsequently wound into a coil at a coiling temperature of 400-750° C., in particular 530-600° C., so that the cold rolling later carried out can be performed without great rolling forces and in order to prevent grain boundary oxidation.

After coiling, the hot strip is cold rolled into a cold flat product at cold rolling degrees of 30-80%, in particular 50-70%, in order to guarantee a sufficiently high driving force for the recrystallisation processes during subsequent annealing. Here, cold rolling degrees of 30-65%, in particular 50-65%, particularly reliably produce the desired result.

The cold flat product obtained is then subjected to a heat treatment which comprises continuously annealing and overageing the cold flat product.

The annealing temperature set during continuous annealing is according to the invention at least 20° C. higher than the A_{c1} temperature of the steel and must not exceed the A_{c3} temperature of the steel.

The A_{c3} temperature of the steel according to the invention can, according to Leslie, see W. C. Leslie “The Physical Metallurgy of Steel”, Mc Graw-Hill Book Company, 1981, p. 275, be calculated according to the following formula [4]:

A_{c3}=910−203(% C)̂0.5−15.2(% Ni)+44.7(% Si)+104(% V)+31.5(% Mo)+13.1(% W)−30(% Mn)−11(% Cr)−20(% Cu)+700(% P)+400(% Al)+400(% Ti) [4]
with % C=C content, % Ni=Ni content, % Si=Si content, % V=V content, % Mo=Mo content, % W=W content, % Mn=Mn content, % Cr=Cr content, % Cu=Cu content, % P=P content, % Al=Al content and % Ti=Ti content of the steel.

The overageing temperature during the overageing treatment is typically set at 350-500° C., in particular 370-460° C., in order to cause the austenite to be further enriched with carbon.

The continuous annealing operation required by the invention, at an annealing temperature which at most reaches the A_{c3} temperature, ensures that the microstructure of the cold flat product produced according to the invention acquires comparably high martensite contents of 12-40% vol. and as a consequence thereof a high level of tensile strength Rₘ of at least 980 MPa. At the same time, the steel produced according to the invention has good formability which is demonstrated by an elongation at break A₈₀ in the transverse direction of at least 15%. The yield point R_{eL} of the steel according to the invention is consistently above 500 MPa. The multi-phase steel according to the invention thereby possesses TRIP properties.

The annealing time over which the cold flat product is annealed at the annealing temperature is typically at most 300 s, so that a sufficiently high proportion of austenite enriched with carbon can form in the two-phase region of the steel.

The duration of the overageing treatment carried out after annealing can be up to 800 s, in order to stabilise the residual austenite in an optimum manner.

In order to obtain a retransformation into ferrite and suppress the formation of perlite, the cold flat product can be rapidly cooled after annealing, starting from the annealing temperature corresponding at most to the A_{c3} temperature, to an intermediate temperature of 500° C. at a cooling rate of at least 5° C./s.

The cold flat product can be annealed in the course of a hot-dip coating operation, in which the cold flat product is provided with a metallic protective coating.

It is also possible to provide the cold strip produced according to the invention with a protective coating after the heat treatment by means of electrolytic coating or another deposition process.

Additionally or alternatively, it can also be advantageous to coat the cold flat product with an organic protective coating.

Optionally, the cold strip obtained can also be subjected to another subsequent rolling operation at degrees of deformation of up to 3.0%, in order to improve its dimensional stability, surface condition and mechanical properties.

The hot strip can be subjected to annealing before cold rolling, in order to improve the cold rollability of the hot strip. This can advantageously be carried out as batch annealing or continuous annealing. The annealing temperatures set during the annealing which prepares the cold rolling are typically 400-700° C.

Carbon increases the amount and the stability of the residual austenite in a steel according to the invention. In steel according to the invention, therefore, at least 0.14% wt. carbon is present, in order to stabilise the austenite to room temperature and prevent a complete transformation of the austenite formed during an annealing treatment into martensite, ferrite or bainite or bainitic ferrite. Over 0.25% wt. carbon contents, however, have a negative effect on the weldability. The positive effects of carbon can be particularly reliably utilised in steel according to the invention if C contents of 0.19-0.24% wt., in particular up to 0.23% wt., are present therein, wherein a minimum content of 0.21% wt. C is particularly advantageous.

Mn like C contributes to the strength and to increasing the amount and the stability of the residual austenite. However, Mn contents which are too high increase the risk of liquation development. Furthermore, they have a negative effect on the elongation at break, since the ferrite and bainite transformations are greatly retarded and as a result comparatively large amounts of martensite remain in the microstructure. The Mn content of a steel according to the invention is set at 1.7-2.5% wt.

Steel according to the invention contains 1.4-2.0% wt. Si. At contents of more than 1.4% wt., Si supports the stabilisation of the residual austenite and suppresses carbide formation in the bainite range during the overageing treatment carried out in the course of processing the steel according to the invention. The bainite transformation does not fully take place as a result of the presence of Si, so that only bainitic ferrite is formed and the carbide formation does not come about. In this way, the stability of residual austenite enriched with carbon aimed for according to the invention is obtained. Furthermore, Si contributes to increasing the strength by means of solid solution hardening. However, with contents of more than 2% wt., a deterioration in the surface quality and the risk of development of brittleness during hot rolling must be expected.

Al is used for removal of oxygen during the production of a steel according to the invention. A steel according to the invention therefore has Al contents of less than 0.1% wt.

Cr and Mo are not wanted in a steel according to the invention and are, therefore, only to be present in ineffective amounts, since they retard the bainitic transformation and hinder the stabilising of the residual austenite. Therefore, according to the invention, the Cr content is limited to less than 0.1% wt. and the Mo content of a steel according to the invention to less than 0.05% wt.

A steel according to the invention contains Nb in contents of 0.02-0.06% wt. and optionally one or more of the elements “Ti, V, B”, in order to increase the strength of the steel according to the invention. Nb, Ti and V form very fine precipitations with the C and N present in the steel according to the invention. These precipitations have a strength-increasing and yield-point-increasing effect through particle hardening and grain refinement. The grain refinement is also very advantageous for the forming properties of the steel.

Ti removes N by chemical combination even during solidification or at very high temperatures, so that possible negative effects of this element on the properties of the steel according to the invention are reduced to a minimum. In order to make use of this effect, in addition to the ever-present Nb up to 0.1% wt. Ti and up to 0.15% wt. V can be added to a steel according to the invention.

Exceeding the upper limits predetermined according to the invention of the contents of micro-alloying elements would result in retarding the recrystallisation during annealing, so that during real production this would either not be able to be achieved or would require an additional furnace output.

The positive effect of the presence of Ti in relation to the removal of the N contents by chemical combination can be particularly used in a targeted way if the Ti content “% Ti” of a multi-phase steel according to the invention fulfils the following condition [3]:

% Ti≧3.4×% N, [3]

wherein “% N” denotes the respective N content of the multi-phase steel.

The positive effect of Ti in a steel according to the invention occurs in a particularly reliable manner if its Ti content is at least 0.01% wt.

By adding up to 0.002% wt. boron, ferrite formation can be retarded during cooling, so that a larger amount of austenite is present in the bainite range. The amount and the stability of the residual austenite can thereby be increased. Furthermore, instead of normal ferrite, bainitic ferrite is formed which contributes to increasing the yield point.

Practice-oriented variants of the steel according to the invention, which are particularly favourable with regard to the costs and the profile of properties of the steel according to the invention, result if the Ti content is limited to 0.02% wt. and B is present in contents of 0.0005-0.002% wt. or V is present in contents of 0.06-0.15% wt.

In the microstructure of a steel according to the invention, at least 10% vol. ferrite, in particular at least 12% vol. ferrite, and at least 6% vol. residual austenite and optionally 5-40% vol. bainite are present, in order on the one hand to ensure the sought after high strength and on the other hand to ensure good deformability of the steel. For this purpose, dependent on the amount of the remaining microstructure constituents, up to 90% vol. of the microstructure can consist of ferrite, wherein the residual austenite contents of the microstructure can be up to a maximum of 25% vol. Contents of at least 12% vol. martensite in the microstructure of the steel according to the invention contribute to its strength, wherein the martensite content should be limited to a maximum of 40% vol., in order to guarantee a sufficient ductility of the steel according to the invention.

Preferably, the residual austenite of a steel according to the invention is enriched with carbon in such a way that its C_{inRA} content calculated according to the formula [1] published in the article by A. Zarel Hanzaki et al. in ISIJ Int. Vol. 35, No. 3, 1995, pp. 324-331 is more than 0.6% wt.

C_{inRA}=(a_{RA}−a_{γ})/0.0044 [1]
with a_{γ}: 0.3578 nm (the lattice constant of the austenite);
   a_{RA}: the respective lattice parameter of the residual austenite in nm measured on the finished cold strip after the final cooling.

The amount of carbon present in the residual austenite has a significant effect on the TRIP properties and the ductility of a steel according to the invention. Accordingly, it is advantageous if the C_{inRA} content is as high as possible.

With regard to the high stability of the residual austenite aimed for, it is furthermore advantageous if it has a grade G_{RA} of residual austenite (“residual austenite grade”) calculated according to formula [2] of more than 6.

G_{RA}=% RA×C_{inRA} [2]
with % RA: the residual austenite content of the multi-phase steel in % vol.;
   C_{inRA}: the C content of the residual austenite calculated according to formula [1].

As proof of the properties of sheets constituted and produced according to the invention, the melts S1 to S7 according to the invention specified in Table 1 were melted and processed into cold flat products K1-K23. Additionally, the A_{c3} temperature calculated according to the above specified formula [4] and the A_{c1} temperature calculated according to the following formula [5], likewise according to the textbook by Leslie already mentioned above, are recorded in Table 1:

Ac1=723−10.7(% Mn)−16.9(% Ni)+29.1(% Si)+16.9(% Cr)+290(% As)+6.38(% W) [5]
with % Mn=Mn content, % Ni=Ni content, % Si=Si content, % Cr=Cr content, % As=As content, % W=W content of the steel.

In the course of producing the'cold flat products K1-K23 which are present here as cold strips or cold sheets, in each case one of the steel melts S1-S7 was cast into a slab. The reheated slab was subsequently hot rolled into a hot strip. The hot strip obtained was coiled and after coiling was cold rolled into a cold strip.

Each cold flat product is subjected to a heat treatment after cold rolling, which comprised annealing at an annealing temperature GT over an annealing time GZ, subsequent accelerated cooling with a cooling rate V to 500° C. and an overageing treatment at an overageing temperature UAT over an overageing time UAt. The different heat treatment variants applied are specified in Table 2.

For each of the cold flat products K1-K23, the steel composition and the parameters “reheating temperature Wat”, “hot rolling final temperature Wet”, “coiling temperature Ht” and “cold rolling degree KWg” set during its production are recorded in Table 3. Additionally, Table 3 specifies for each cold flat product K1-K23 which of the heat treatments listed in Table 2 was applied during its production. Finally, in Table 3 the tensile strength Rₘ, the yield point R_{eL}, the elongation at break A₈₀ in the transverse direction, the residual austenite content RA, the C content C_{inRA} of the residual austenite, the grade G_{RA} of the residual austenite and the martensite content M are specified for each of the cold flat products K1-K23 as well.

The tests prove that cold flat products K1-K20, which in each case have an optimum combination consisting of a tensile strength Rm of more than 980 MPa and an elongation at break A₈₀ in the transverse direction of more than 15%, can be reliably produced using the approach according to the invention. In contrast, the cold flat products K21, K22 and K23, in each case annealed at an annealing temperature GT above the A_{c3} temperature of the respective steel, do not reach this strength level.

TABLE 1
(content data in % wt., remainder iron and unavoidable impurities)

| Melt | C | Si | Mn | Al | Nb | V | Ti | P | S | N | B | A_{c3} | A_{c1} |
|---|---|---|---|---|---|---|---|---|---|---|---|---|---|
| S1 | 0.217 | 1.75 | 1.85 | 0.021 | 0.04 | 0.01 | 0.01 | 0.004 | 0.003 | 0.0016 | 0.0004 | 853 | 754 |
| S2 | 0.24 | 1.75 | 1.8 | 0.021 | 0.04 | 0.01 | 0.02 | 0.004 | 0.003 | 0.0036 | 0.001 | 853 | 755 |
| S3 | 0.217 | 1.75 | 2.2 | 0.021 | 0.04 | 0.01 | 0.01 | 0.004 | 0.003 | 0.0049 | 0.0004 | 842 | 750 |
| S4 | 0.23 | 1.65 | 2.0 | 0.05 | 0.04 | 0.02 | 0.01 | 0.015 | 0.003 | 0.005 | 0.0005 | 861 | 750 |
| S5 | 0.21 | 1.75 | 1.85 | 0.02 | 0.04 | 0.01 | 0.01 | 0.004 | 0.002 | 0.0016 | 0.0004 | 854 | 754 |
| S6 | 0.226 | 1.44 | 2.47 | 0.08 | 0.06 | 0.02 | 0.01 | 0.005 | 0.002 | 0.0025 | 0.0003 | 844 | 738 |
| S7 | 0.211 | 1.97 | 1.76 | 0.048 | 0.02 | 0.08 | 0.02 | 0.009 | 0.003 | 0.0037 | 0.0008 | 893 | 761 |

TABLE 2

| Heat | GT | GZ | V | UAT | UAt |
|---|---|---|---|---|---|
| treatment | [° C.] | [s] | [° C./s] | [° C.] | [s] |
| A | 820 | 60 | 15 | 375 | 60 |
| B | 820 | 60 | 15 | 375 | 120 |
| C | 820 | 60 | 15 | 375 | 360 |
| D | 820 | 60 | 15 | 425 | 30 |
| E | 820 | 60 | 15 | 425 | 60 |
| F | 820 | 60 | 15 | 425 | 120 |
| G | 820 | 60 | 15 | 450 | 30 |
| H | 820 | 60 | 15 | 450 | 60 |
| I | 820 | 60 | 15 | 450 | 120 |
| J | 820 | 60 | 50 | 425 | 30 |
| K | 820 | 60 | 50 | 425 | 60 |
| L | 820 | 60 | 50 | 425 | 120 |
| M | 820 | 60 | 100 | 425 | 120 |
| N | 840 | 60 | 100 | 425 | 120 |
| O | 860 | 60 | 100 | 425 | 120 |
| P | 800 | 100 | 15 | 375 | 120 |
| Q | 820 | 80 | 15 | 375 | 60 |
| R | 840 | 80 | 15 | 425 | 60 |
| S | 860 | 80 | 50 | 425 | 120 |

TABLE 3

| | | | | | | | | | | | | | | | Acc. |
|---|---|---|---|---|---|---|---|---|---|---|---|---|---|---|---|
| | | Anneal. | WaT | WeT | HAT | KWg | Rₑₗ | Rₘ | A₈₀ | RA | a_{RA} | C_{inRA} | Grade | Martensite | to |
| | Melt | Nr. | [° C.] | [° C.] | [° C.] | [%] | [Mpa] | [Mpa] | [%] | [% vol.] | [nm] | [% wt.] | RA | [%] | inv.? |
| K1 | S1 | K | 1101 | 890 | 600 | 45 | 542 | 986 | 21.8 | 19.0 | 0.3610 | 0.73 | 13.87 | 12 | YES |
| K2 | S1 | R | 1242 | 890 | 540 | 50 | 583 | 1042 | 21.2 | 19.8 | 0.3609 | 0.71 | 14.06 | 20 | YES |
| K3 | S1 | N | 1235 | 820 | 520 | 56 | 571 | 1027 | 20.3 | 16.9 | 0.3608 | 0.89 | 11.66 | 21 | YES |
| K4 | S2 | J | 1190 | 880 | 600 | 40 | 615 | 1086 | 16.9 | 15.0 | 0.3609 | 0.71 | 10.65 | 37 | YES |
| K5 | S2 | K | 1222 | 900 | 510 | 56 | 627 | 1049 | 20.9 | 17.5 | 0.3611 | 0.76 | 13.30 | 29 | YES |
| K6 | S2 | L | 1178 | 910 | 510 | 64 | 633 | 1025 | 21.4 | 18.5 | 0.3611 | 0.75 | 13.88 | 19 | YES |
| K7 | S3 | D | 1180 | 900 | 490 | 62 | 604 | 1098 | 16.5 | 15.5 | 0.3607 | 0.66 | 10.23 | 37 | YES |
| K8 | S3 | F | 1250 | 950 | 490 | 60 | 632 | 1015 | 19.1 | 17.5 | 0.3611 | 0.75 | 13.13 | 18 | YES |
| K9 | S3 | I | 1109 | 910 | 450 | 57 | 621 | 1058 | 18.7 | 16.5 | 0.3611 | 0.74 | 12.21 | 32 | YES |
| K10 | S4 | H | 1223 | 890 | 400 | 54 | 650 | 1100 | 16.7 | 15.0 | 0.3607 | 0.65 | 9.75 | 38 | YES |
| K11 | S4 | G | 1114 | 900 | 520 | 61 | 617 | 1023 | 20.1 | 16.3 | 0.3609 | 0.7 | 11.41 | 26 | YES |
| K12 | S5 | P | 1193 | 870 | 510 | 58 | 580 | 1012 | 21.1 | 18.3 | 0.3611 | 0.74 | 13.54 | 27 | YES |
| K13 | S5 | Q | 1200 | 830 | 700 | 45 | 582 | 992 | 18.6 | 17.2 | 0.3610 | 0.72 | 12.38 | 14 | YES |
| K14 | S5 | B | 1202 | 920 | 560 | 45 | 530 | 1008 | 22.1 | 19.1 | 0.3610 | 0.73 | 13.94 | 18 | YES |
| K15 | S6 | L | 1209 | 890 | 450 | 50 | 620 | 1089 | 17.1 | 15.5 | 0.3609 | 0.7 | 10.85 | 40 | YES |
| K16 | S6 | M | 1203 | 890 | 580 | 75 | 612 | 1070 | 17.8 | 14.0 | 0.3606 | 0.63 | 8.82 | 33 | YES |
| K17 | S6 | G | 1190 | 870 | 620 | 70 | 580 | 1063 | 19.4 | 17.7 | 0.3609 | 0.71 | 12.57 | 33 | YES |
| K18 | S7 | A | 1197 | 900 | 500 | 49 | 602 | 1099 | 20.9 | 17.0 | 0.3611 | 0.75 | 12.75 | 40 | YES |
| K19 | S7 | C | 1201 | 923 | 630 | 60 | 602 | 1085 | 19.2 | 16.0 | 0.3608 | 0.68 | 10.88 | 36 | YES |
| K20 | S6 | I | 1190 | 910 | 625 | 61 | 613 | 1038 | 19.8 | 17.1 | 0.3609 | 0.7 | 11.97 | 28 | YES |
| K21 | S5 | E | 1200 | 898 | 600 | 50 | 551 | 993 | 21.6 | 17.0 | 0.3611 | 0.75 | 12.75 | 13 | YES |
| K22 | S4 | 0 | 1191 | 860 | 612 | 56 | 662 | 944 | 17.3 | 13.6 | 0.3605 | 0.62 | 8.43 | 11 | NO |
| K23 | S7 | S | 1198 | 860 | 620 | 57 | 554 | 936 | 22.1 | 22.5 | 0.3610 | 0.73 | 16.43 | 9 | NO |

1. A method for producing a cold flat product, comprising the following production steps:
melting and casting a multi-phase steel into a semi-finished product which contains, in addition to iron and unavoidable impurities, (in % wt.)
C: 0.14-0.25%,
Mn: 1.7-2.5%,
Si: 1.4-2.0%,
Al: <0.1%,
Cr: <0.1%,
Mo: <0.05%,
Nb: 0.02-0.06%,
S: up to 0.01%,
P: up to 0.02%,
N: up to 0.01%
and optionally at least one element from the group Ti, B, and V according to the following stipulation:
Ti: up to 0.1%,
B: up to 0.002%,
V: up to 0.15%;
hot rolling the semi-finished product into a hot strip starting from an initial temperature of 1100-1300° C. and ending at a final temperature of 820-950° C.;
coiling the hot strip at a coiling temperature of 400-750° C.;
optionally annealing the hot strip;
cold rolling the hot strip into the cold flat product at cold rolling degrees of 30-80%;
heat treating the cold flat product obtained, wherein the heat treatment comprises
continuously annealing the cold flat product at an annealing temperature which is at least 20° C. higher than the A_{c1} temperature and is at most the same as the A_{c3} temperature of the multi-phase steel and
overageing the cold flat product at an overageing temperature of 350-500° C.

2. The method according to claim 1, wherein the annealing time over which the cold flat product is annealed at the annealing temperature is at most 10-300 s.

3. The method according to claim 1, wherein the duration of the overageing treatment carried out after annealing is up to 800 s.

4. The method according to claim 1, wherein the heat treatment further comprises cooling the cold flat product starting from the annealing temperature to an intermediate temperature of 500° C. at a cooling rate of at least 5° C./s.

5. The method according to claim 1, wherein the coiling temperature is 530-600° C., the cold-rolling degree is 50-70%, the annealing temperature is 800-830° C. or the overageing temperature is 370-460° C.

6. The method according to claim 1, wherein the cold flat product is coated with a metallic or organic protective coating.

7. The method according to claim 1, wherein the annealing of the hot strip optionally performed after the coiling and before the cold rolling is carried out as batch annealing or as continuous annealing at 400-700° C.

8. A multi-phase steel comprising (in % wt.)
C: 0.14-0.25%,
Mn: 1.7-2.5%,
Si: 1.4-2.0%,
Al: <0.1%,
Cr: <0.1%,
Mo: <0.05%,
Nb: 0.02-0.06%,
S: up to 0.01%,
P: up to 0.02%,
N: up to 0.01%,
and optionally at least one element from the group Ti, B, and V according to the following stipulation:
Ti: up to 0.1%,
B: up to 0.002%,
V: up to 0.15%,
with the remainder iron and unavoidable impurities, wherein in the microstructure of the steel at least 12-40% vol. martensite, at least 6% vol. residual austenite and optionally 5-40% vol. bainite are present and the steel has a tensile strength Rₘ of at least 980 MPa and an elongation at break A₈₀ measured in the transverse direction of more than 15%.

9. The multi-phase steel according to claim 8, wherein the C_{inRA} content of the residual austenite calculated according to formula [1] is more than 0.6% wt.:
C_{inRA}=(a_{RA}−a_{γ})/0.0044 [1]
with a_{γ}: 0.3578 nm (the lattice parameter of the austenite);
a_{RA}: the respective lattice parameter of the residual austenite measured in nm on the finished cold strip after final cooling.

10. The multi-phase steel according to claim 9, wherein the multi-phase steel has a grade G_{RA} of the residual austenite calculated according to formula [2], for which G_{RA}>6 applies:
G_{RA}=% RA×C_{inRA} [2]
with % RA: the residual austenite content of the multi-phase steel in % vol.;
C_{inRA}: the C content of the residual austenite
calculated according to formula [1].

11. The multi-phase steel according to claim 8, wherein the C content is 0.19-0.23% wt.

12. The multi-phase steel according to claim 8, wherein the Ti content is at least 0.01% wt.

13. The multi-phase steel according to claim 8, wherein the Ti content % Ti fulfills the condition [3]:
% Ti≧3.4×% N [3]
with % N: the N content of the multi-phase steel.

14. The multi-phase steel according to claim 8, wherein the B content is at least 0.0005% wt.

15. The multi-phase steel according to claim 8, wherein the V content is at least 0.06% wt.

16. A cold flat product produced by applying the method according to claim 1 and comprising of a multi-phase steel comprising
C: 0.14-0.25%,
Mn: 1.7-2.5%,
Si: 1.4-2.0%,
Al: <0.1%,
Cr: <0.1%,
Mo: <0.05%,
Nb: 0.02-0.06%,
S: up to 0.01%,
P: up to 0.02%,
N: up to 0.01%,
and optionally at least one element from the group Ti, B, and V according to the following stipulation:
Ti: up to 0.1%,
B: up to 0.002%,
V: up to 0.15%,
with the remainder iron and unavoidable impurities,
wherein in the microstructure of the steel at least 12-40% vol. martensite, at least 6% vol. residual austenite and optionally 5-40% vol. bainite are present and the steel has a tensile strength Rₘ of at least 980 MPa and an elongation at break A₈₀ measured in the transverse direction of more than 15%.
